(19) United States
(12) Patent Application Publication
(10) Pub. No.: US 2024/0193713 A1
(43) Pub. Date: Jun. 13, 2024

(54) SYSTEM AND METHOD FOR DYNAMIC DIVISION OF PERSONAL ITEMS

(71) Applicant: Willdivi Inc., Weston, CT (US)

(72) Inventor: Todd L. Landen, Weston, CT (US)

(21) Appl. No.: 18/520,861

(22) Filed: Nov. 28, 2023

Related U.S. Application Data
(60) Provisional application No. 63/386,451, filed on Dec. 7, 2022.

(51) Int. Cl. G06Q 50/18; G06F 9/451; G06F 16/54

(52) U.S. Cl. CPC G06Q 50/186; G06F 9/451; G06F 16/54

(57) ABSTRACT

What is disclosed is a system and method in the form of a computer application to be used to divide personal items among a plurality of beneficiaries. The system may provide multiple interfaces for access by the property owner, an executor, and the beneficiaries. Each type of user has different permissions to access information and functions in the application. The property owner can enter data associated with all of the items in the estate, information about the beneficiaries, and use a dynamic calculator and worksheet to view how the division of items are suggested today (Suggestion View), and how they might look in the future (Beneficiary's View). The system and method also provide for the storage of the owner's media (e.g., photographs, videos, messages, and documents) and account passwords.

The present application claims the benefit of U.S. Provisional Patent Application No. 63/386,451 filed on Dec. 7, 2022, the entirely of which is incorporated herein by reference.

### FIELD

The present disclosure relates generally to a system and method for dynamically dividing personal items, and in particular to a system and method for providing real-time communication about the allocation and distribution of personal items among beneficiaries for an account holder and their executor and beneficiaries after death.

### BACKGROUND

Upon a person's death, his or her personal property and possessions are generally distributed based on a legal document, such as a will or last testament. However, using a will to divide personal items in an estate can lead to various challenges and disputes among family members and other beneficiaries. Because wills often rely on subjective language to distribute personal items, such as “my personal effects” or “items of sentimental value,” these terms can be open to interpretation and lead to disagreements among beneficiaries. Personal items, like family heirlooms or sentimental possessions, can carry strong emotional attachments for different heirs. When there are multiple beneficiaries, deciding who gets what can be challenging, especially if the deceased did not provide for detailed distribution of the items in the estate. This can often result in conflicts and disagreements. Wills also may not provide clear guidance on how to handle specific situations, such as the distribution of jointly owned property, items stored in trust, or items with co-owners. Beneficiaries may also dispute the condition and value of items when they are distributed and over time, personal items can be lost, or damaged. The present disclosure addresses these and other issues.

### BRIEF DESCRIPTION OF THE DRAWINGS

Embodiments are described in detail below with reference to the accompanying drawing figures:

FIG. 1 is a simplified illustration of an exemplary embodiment of a graphical user interface for a starting menu for various users or the account holder(s), executor, and beneficiaries according to the teachings of the present disclosure;

FIG. 2 is a simplified illustration of an exemplary embodiment of an executor's detailed view of a personal profile according to the teachings of the present disclosure;

FIGS. 3 and 4 are simplified illustrations of an exemplary embodiment of various item interface screens detailing one or more items belong to the account holder to be distributed according to the teachings of the present disclosure;

FIG. 5 is a simplified illustration of an exemplary embodiment of an add beneficiary interface screen that details more than one type of beneficiary according to the teachings of the present disclosure;

FIG. 6 is a simplified illustration of an exemplary embodiment of a user setting interface screen according to the teachings of the present disclosure;

FIG. 7 is a simplified illustration of an exemplary embodiment of an item detail interface screen that illustrates suggestions by the account holder on how beneficiaries may divide a personal item according to the teachings of the present disclosure;

FIG. 8 is a simplified and further illustration of an exemplary embodiment of an item detail calculator interface screen being used as a worksheet by an account holder according to the teachings of the present disclosure;

FIGS. 9-12 are simplified illustrations of an exemplary embodiment of various item detail interface screens for use both to make suggestions by the account holder on how their belongings are to be divided, and by beneficiaries at different stages of an auction of the item being divided according to the teachings of the present disclosure;

FIG. 13 is a simplified illustration of an exemplary embodiment of a beneficiary alert interface screen in use by beneficiaries during an auction of various items according to the teachings of the present disclosure;

FIG. 14 is a simplified illustration of an exemplary embodiment of a media interface screen used for distributing photos, videos, documents, and messages to beneficiaries according to the teachings of the present disclosure; and

FIG. 15 is a simplified block diagram of an exemplary embodiment of a computing operating environment according to the teachings of the present disclosure.

### DETAILED DESCRIPTION

The system and method described herein allow a property owner to divide or bequeath personal belongings to one or more beneficiaries. The system and method may be embodied as a computer application stored and executing on a mobile device or other computing platforms. The computer application may also be implemented and offered via a SaaS (Software as a Service) model that is hosted in one or more cloud servers and accessible to users over the internet using various computing devices.

The inventive concept is described herein as a system and a method, where these terms are used interchangeably to refer to all embodiments of the inventive concept. The description herein uses the terms “account holder” and “primary user” to refer to the property owner who is interested in using the system and method (i.e., computer application) to provide a detailed specification of how and to whom the items in the estate should be distributed. The term “secondary user” is used to refer to the “executor” of the estate or the person assigned with the responsibility of overseeing the distribution of items in the estate. The terms “beneficiary” or “beneficiary users” are used herein to refer to users of the computer application who have been identified by the property owner as persons who will receive at least a portion of one or more items in the estate. The inventive concept contemplates a computer application that will enable these persons of various roles to enroll or register as users in the application and to access information regarding the items in the estate.

In an embodiment of the inventive concept, a primary user or account holder may use the application to record and document their personal property during their lifetime and identify the beneficiaries of these items. Disclosed herein is a system to be used either in place of a will, in addition to a will, or as part of a codicil to a will. The system disclosed herein enables a primary user (account holder) to express their wishes regarding the division of personal belongings while also giving increased decision power to the beneficiaries. Moreover, the system and method disclosed herein may find applications in the disposition and allocation of personal items for users who contemplate giving away the bulk of their belongings during their lifetime, or a manager who oversees and manages multiple estate sales for multiple executors.

In an embodiment, a method is disclosed for reducing potential contention and conflict between beneficiaries who might otherwise resent or dispute how the primary user's personal belongings have been divided among them after the primary user's death. More particularly, the system enables the primary user to list the current value of each item, and to indicate their desire of how to divide an item among multiple beneficiaries. Additionally, the system and method may enable the primary user to bequeath an item as a gift, to distribute a monetary value between beneficiaries after an item is sold privately, or to divide the realized value proportionally after an auction among one or more beneficiaries.

In an embodiment, a method is disclosed for the executor to act as a moderator and negotiator to assist in resolving disputes between the beneficiaries outside of the courtroom. More particularly, the system may enable the executor the right to restrict a user from being part of an auction because of age, personality, availability and to initiate an auction or to extend the time limit for an auction if needed. Additionally, the primary user may indicate their wishes that the executor has such rights to resolve conflicts to avoid unnecessary lawsuits by indications in a settings interface screen 800.

In an embodiment, the system includes a user interface for bequeathing messages, photos, videos, passwords, and documents to one or more beneficiaries. In an embodiment, an executor may distribute one or more items to one or more beneficiaries in the application, when a primary user is incapacitated or passed.

In an embodiment, the system allows for multiple user profiles, each with different permissions. For example, a secondary user, such as an executor, may have different permissions than the owner of the items, referred herein as the primary user. Additionally, multiple additional users, such as beneficiaries, may also have different permissions than the primary and secondary users. Thus, a single system is pertinent and useful to all parties involved in the accepting or dividing up of personal belongings of the primary user(s).

In an embodiment, the system allows a primary user to specify beneficiaries who may be primary beneficiaries (such as immediate family members), secondary beneficiaries (such as more distant family members and others), friends, neighbors, trusts, charitable organizations or others. More particularly, the system allows the primary user to make unlimited updates over time, as desired. Specifically, the primary user may name beneficiaries and specify how a plurality of personal belongings should be divided or left to beneficiaries without the burden of codicils, revisions to wills, or resulting legal fees.

Additionally, beneficiaries may participate in the process of dividing and valuing personal belongings after the primary user's demise. More particularly the primary beneficiaries, who may include a variety of individuals, may be given more rights and permissions than secondary beneficiaries and others. In an embodiment, the primary user (account holder) can give permissions so the executor can consider a beneficiary who may be incapacitated or cannot participate in an auction. In addition, the executor may have permission to add a new item, not added by the account holder, that would be equally divided among the primary beneficiaries or as indicated. The account holder may provide certain permissions for the executor, to help them fairly divide the items of the account holder. For example, if a specific beneficiary is too young or personally difficult, the executor may or may not have permission to bid for them. For example, the account holder can give the executor permission to specify that an item is very valuable and/or what the value is. Thus, if a particular item may be inherited by one beneficiary, an agreement may accompany the item so if the item is sold in the future, the proceeds would be divided among the named beneficiaries.

In an embodiment, a beneficiary may desire to have the ability to change or provide input regarding the division of items. The system and method disclosed herein enable one or more users to dynamically communicate and indicate their desires regarding the disposition of items. For example, a user, such as a beneficiary, may decline a gift but receive money instead; receive an item but see a share of the financial value to another named beneficiary; make a financial offer for an item in an auction with other users where the value may be divided proportionally among other users; agree to have one of the users take possession of a so-called “priceless” item but accept their pledge to share a higher sale of that item in the future; suspend a decision on how an item is divided or place the item in storage; dispute an item's valuation or the division; recommend a formal appraisal; suggest an item be sold privately in order to realize a higher financial value that is divided proportionally; suggest the item be sold in an estate sale with proceeds divided among users as specified by the primary user and/or other means of action.

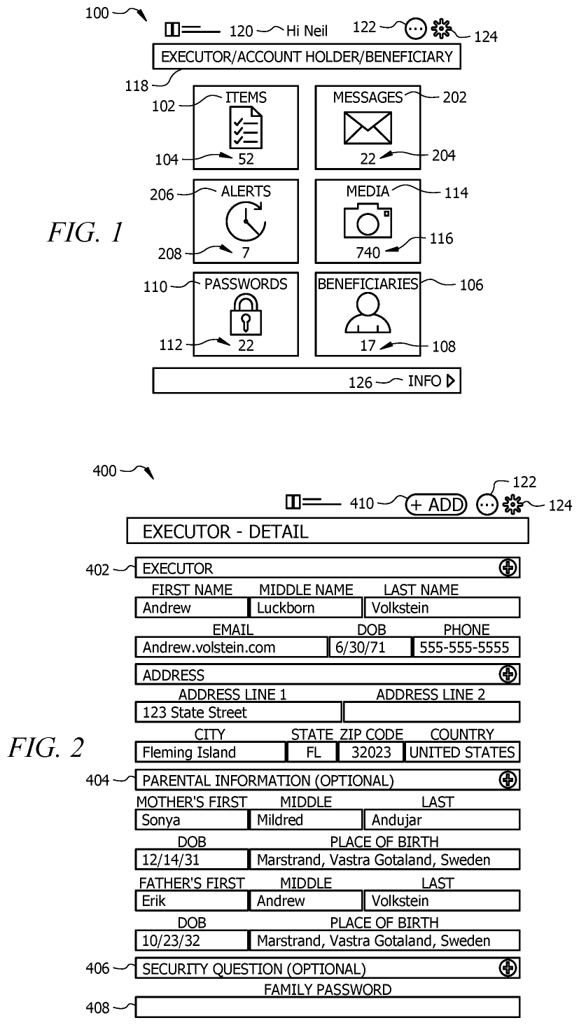

FIG. 1 illustrates an example of a top-level screen 100 for the application after a successful log in. Depending on the role/responsibility of the user, i.e., account holder (primary user), executor (secondary user), or beneficiary, the display will vary to provide different graphical icons to provide the user access to a variety of information. For example, for an account holder (i.e., the owner of personal items to be divided), may be provided an initial screen with multiple clickable graphical icons for the user to view, enter, and edit information: an items icon 102 with the number of items 104 that are currently saved in the system associated with this primary user/account holder, a beneficiaries icon 106 with the number of beneficiaries 108 that are saved in the system associated with this account holder, a passwords icon 110 with the number of passwords 112 that are saved in the system associated with this account holder, and a media icon 114 is displayed with the number of media files 116 that are currently saved in the system associated with this account holder. The type of profile 118, such as “account holder” may be indicated in the primary user interface 100, such as at the top of screen. A user identifier 120, such as a name, may also be indicated in the primary user interface 100, such as at the top of the screen. A messaging button 122 and/or a settings button 124 may also be provided in the primary user interface 100. Other icons or buttons, such as info button 126, may be provided in primary user interface 100 to provide additional functionalities regarding the use of the application as support. Other icons or buttons may be provided in secondary user interface 200 to provide additional functionalities.

For a second type of user (the secondary user), such as an executor, the initial screen after successful log in may also include multiple clickable graphical icons to enable access of different types of information. For example, the executor may be provided the items icon 102 that cannot be fundamentally edited, but add newly found items and make minor edits, beneficiaries icon 106, passwords icon 110, and media icon 114, plus some additional icons: messages 202 and alerts 206. For the executor, the beneficiaries icon 106 202 provides access to a chat message board for communication with the beneficiaries. The messages icon 202 is shown with the number of messages 204 that are currently saved in the system. The alerts icon 206 is shown with the number of alerts 208 that are currently saved in the system associated with this and other users. Although certain icons may be associated with the same types of information, they may have different permissions depending on whether the user is the account holder, the executor, or a beneficiary.

The secondary user (the executor) typically has fewer rights or permissions than the primary user/account holder. However, the secondary user has access to different interfaces to facilitate their responsibility or role of dividing up personal belongings after the death of the account holder. For example, the executor user cannot edit the distribution of items already specified in the application by the account holder. However, the executor may have permissions to update certain fields, including category, location, and/or condition, monetary amounts, to sell items privately, to appraise items, to add new items not yet listed, to start and restart auctions, and to message users to facilitate the division of the items.

For a third type of user, such as a beneficiary, after successful log in, the top-level screen may have a different set of clickable graphical icons: the items icon 102, the alerts icon 206, the media icon 114, with different functions than described above. The beneficiary's top-level screen may include an icon for chat with the executor instead of with other beneficiaries. The icons accessible by the beneficiary may be associated with different permissions tied to the particular beneficiary user.

Each beneficiary user may access the application via a user interface specific for the beneficiaries, which gives them different permissions than the account holder and the executor. A beneficiary user may access the parts of the application relating specifically to the items that they might inherit or receive. Thus, each beneficiary user may only view items for which he/she is listed as a beneficiary. The beneficiary user may also send messages to the executor and receive messages therefrom relating to specific items for which the beneficiary user has been designated by the account holder user.

In an embodiment, the primary user (account holder) may assign one or more executors, and also add optional security questions to allow one or more executors to gain access to the application after the death of the primary user. FIG. 2 illustrates an example of an executor detail user interface 400 that includes fillable data fields where the primary user may add contact information and demographic information 402 about the person to be assigned the role of executor over the account holder's personal belongings in the system. Additional information can also be entered in the executor detail user interface 400, such as the primary user's parental information 404, one or more security questions 406, and a password 408. Similar to the primary user interface 100, the executor detail user interface 400 may also include a support button 122 and/or settings button 124. In an embodiment, executor detail user interface 400 may also include an “add” button 410 that allows the primary user to add additional executors (secondary users). Other icons or buttons may be provided in executor detail user interface 400 to provide additional functionalities.

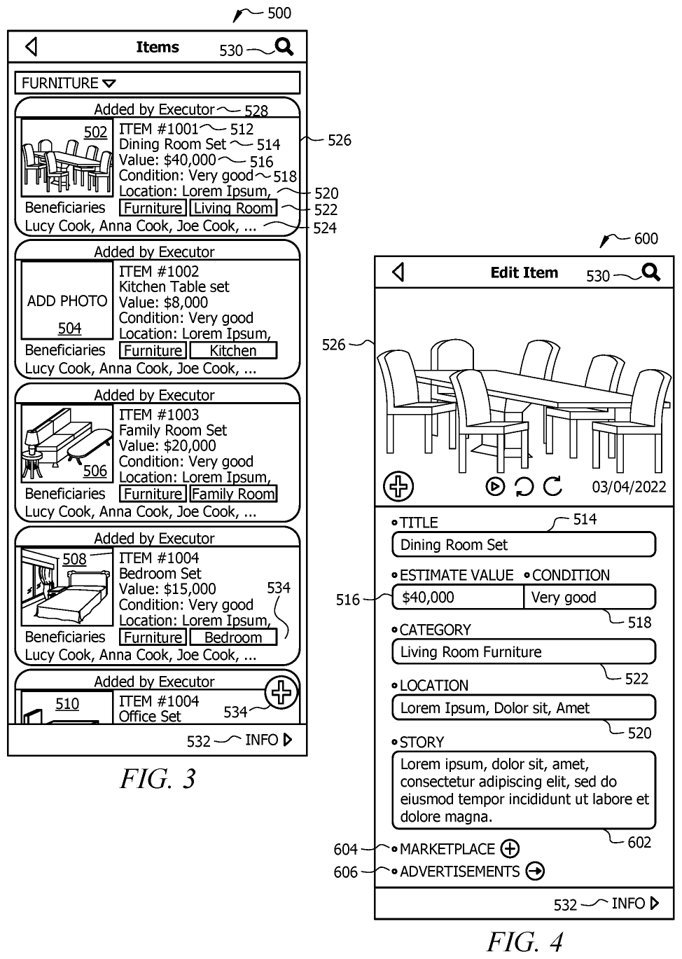

Also referring to FIG. 1, the primary user or account holder has the ability to access and edit all data records in the application. Thus, the permissions associated with the primary user are unrestricted. When the primary user clicks on the items icon 102, the primary user accesses an items interface 500, an example of which is shown in FIG. 3. The items interface 500 includes a list of items that the primary user has entered into the system for division and disposition. In an alternate embodiment, there may be multiple primary users in a joint account, where each primary user may add new items, delete items, and/or edit the properties of the listed items. Thus, the system and method may accommodate individual accounts or joint accounts. In one embodiment of the invention, if one of the primary users predeceases the other, the items can either be transferred in full to their partner or some items may be bequeathed to beneficiaries as indicated in settings.

FIG. 3 illustrates an example of the items list interface 500, which lists personal items 502-510 that have been entered into the system by the account holder(s). Each item, such as item 502, may include one or more of the following exemplary information associated therewith: item number 512, item title 514, item value 516, item condition 518, item location 520, one or more item categories 522, associated beneficiaries 524, and item image 526. The items listing may also include an origin field 528 for indicating who added the item, such as the account holder or the executor. In another embodiment, the user interface may not include the origin field 528 for an item that was added by the executor as opposed to the account holder (by default). Further, the account holder or executor may group similar items together as one item, by type, or by location (e.g., office items or bathroom items). The beneficiary data field 524 identifies one or more persons that have been designated as the beneficiaries of this particular item. The items interface 500 may provide a listing of a plurality of items, which may further be sorted by category 522, such as: furniture, fine art (e.g., paintings, sculptures), jewelry, mementos, clothing, real estate, vacation timeshare, books, treasured collections (e.g., baseball cards, matchbooks, refrigerator magnets, sports paraphernalia, etc.), kitchen items, exercise equipment, garden/yard items, etc. The items interface 500 may include a search function 530 to allow a user to enter keywords to find specific items. The items interface 500 also includes an “info” button 532, which provides more detailed information or relevant support issues. The items interface 500 may also include an “add” button 534 to allow the account holder or the executor to add additional items to the system.

When the primary user (account holder) clicks on a particular item in the list, such as an item 502, the item detail user interface 600 is displayed, as shown in FIG. 4. Alternatively or additionally, when a user clicks on the “add” button 534, or on any list item, the item detail user interface 600 is displayed. The item detail user interface 600 enables the primary user to edit all of the property fields of the item. For example, the account holder may edit the item image 526, add additional images, and edit any of the data associated with the item: item title 514, item value 516, item condition 518, item location 520, and/or item category 522. In an embodiment, a secondary user, such as the executor, may have unique permissions to edit an item. For example, the secondary user may have the ability to edit the following properties associated with an item including the location, condition, and the current or estimated value. Additionally, the secondary user may also have the ability to add and assign newly found items to the list of items if the item was not already cataloged in the system 528.

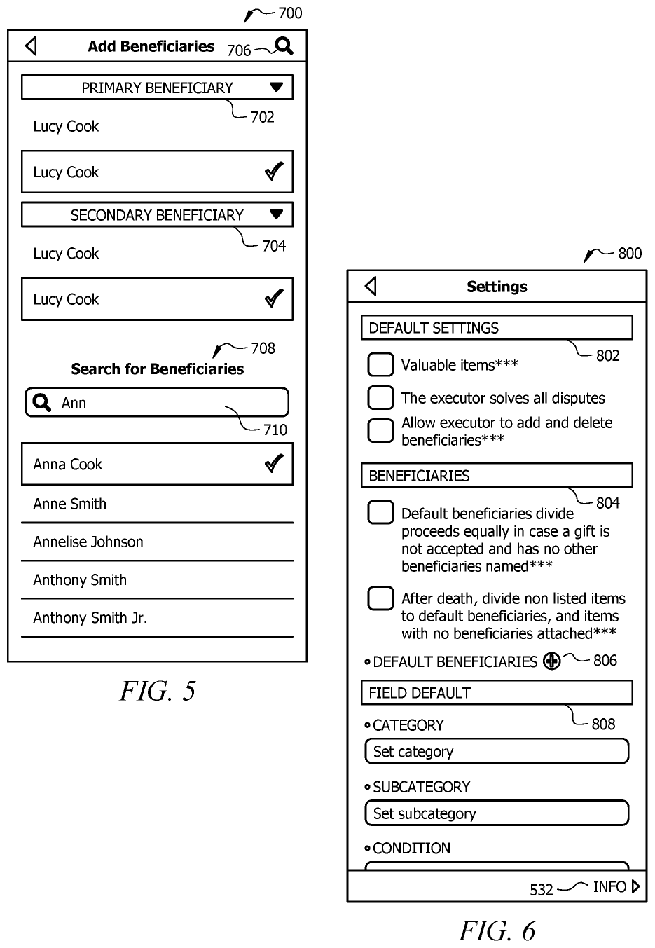

Additionally, the account holder may add a background or story 602 associated with the item 502, that may be accessible by the executor and beneficiaries who are associated with the item. The item detail user interface 600 may also include links, such as to a marketplace 604 and/or advertisements 606. The account holder can also click on the item image 526 to view an enlarged image of the item. The account holder may also enter beneficiaries via a beneficiary user interface 700, such as shown in FIG. 5. FIG. 5 illustrates an exemplary beneficiary user interface 700. The beneficiary user interface 700 may include the type of beneficiary (primary 702 or secondary 704) to be added. The beneficiary user interface 700 may also include a search button 706, which may open a search window 708. The search window 708 may allow a user to enter a search field 710 to search for a name in the system and select a name for adding to the fields 702 and/or 704. The account holder can add beneficiaries (by entering name, address, telephone number, email address, etc.), and name them as primary, secondary, friends, neighbors, trusts, and/or charitable organizations. The account holder can assign one or more beneficiaries to a specific item to inherit the item in whole or in part. In an embodiment, beneficiaries may also be added to the system before being associated with a particular item.

Referring back to FIG. 3, the items interface 500 may be capable of being sorted to allow the user to more easily view the items. a user may choose how the items listing will be displayed, such as sort by category, location, condition, timeline (such as most recent), etc. A user may also search the items listing by beneficiary to view which items are associated with a particular beneficiary. Thus, the system allows account holder to catalog personal belongings using text, settings, photos, videos, estimated values and other properties and qualities for suggested distribution to beneficiaries with the ability to sort data in a list.

FIG. 6 illustrates a settings user interface 800, which may be accessed by clicking on the settings button 124 on the primary user interface 100 (FIG. 1), for example. The settings user interface 800 allows the account holder to provide default settings for multiple fields. For example, the account holder may provide general default settings 802 that can be selected, such as: rules for valuable items, the executor (secondary user) solving all disputes, allowing executor to add and delete beneficiaries (if deceased or otherwise unavailable). Additionally, the account holder may provide default settings for the beneficiaries 804, such as default beneficiaries divide proceeds equally in case a gift is not accepted and has no other beneficiaries named; or after death divide non listed items to default beneficiaries and to items with no beneficiaries attached. Additionally, the account holder may add default beneficiaries at 806. The account holder may also provide default settings for the information fields of the item 808, such as categories, subcategories, conditions, etc.

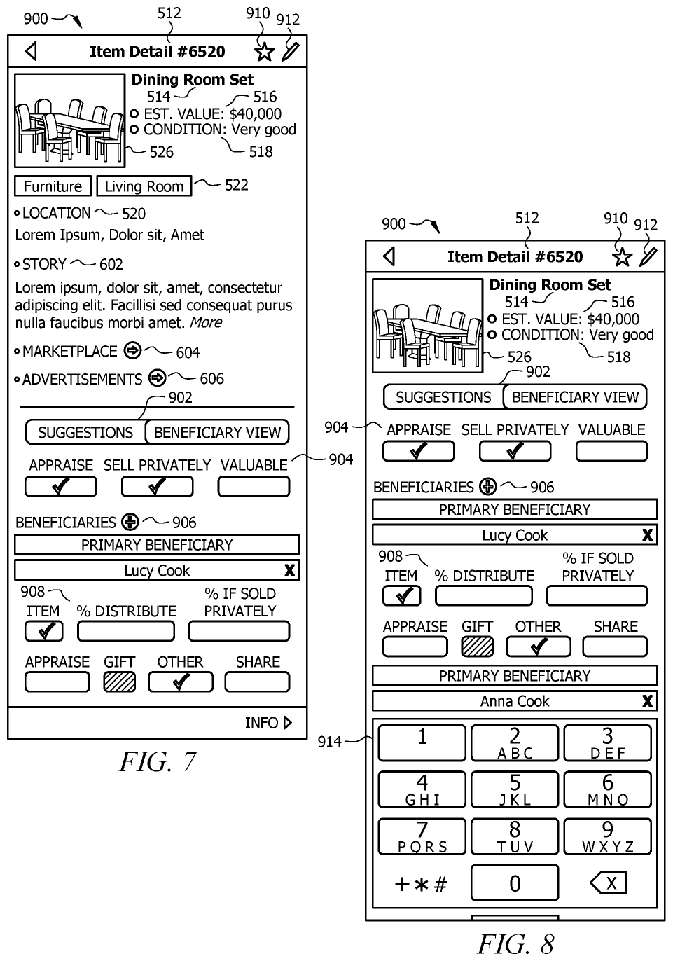

FIG. 7 illustrates an example of an item detail user interface 900 for account holder. The item detail user interface 900 may include item number 512, item title 514, item value 516, item condition 518, item location 520, item category 522, story 602, and links to marketplace 604 and advertisements 606. The item detail user interface 900 may also include a window for displaying a suggestion view or a beneficiary view. In FIG. 7, the suggestions view 902 is displayed with a star icon 910 (for a favorite item) and an edit icon 912.

The suggestions view 902 in FIG. 7 may include check-boxes 904 for indicating, for example, permission to appraise, sell privately, and consider the item to be highly valuable. A beneficiaries drop-down window 906 may also be provided, which may indicate the beneficiaries selected for the particular item. In FIG. 7, under the primary beneficiary heading, check-boxes 908 may also be provided for indicating if a beneficiary should receive the item, or receive a percentage of a financial distribution, or receive a percentage if sold privately as an indication for how the account holder would like to leave this item to one or more beneficiaries. In this case, item #6520, the account holder suggests that the item might be appraised and/or sold privately to reap a higher financial benefit. Additionally, the account holder also has the option to simply gift the item, or to suggest beneficiaries share the item as an heirloom, and/or use the “other” field to indicate their desire to store the item, enter the item into an estate sale, or dispute the action being taken. More particularly, in a financial sale, the account holder may enter specific percentages for each beneficiary (evenly or unevenly). The account holder may also indicate a preference for beneficiaries to share an item physically with other beneficiaries over a specified time as an heirloom.

With reference to FIG. 7, the account holder creates suggestions (e.g., the suggestions view mode) on how to divide up personal belongings and assign beneficiaries to items to inherit in whole or in part, where the financial value may be shared in specific percentages or otherwise indicated. The account holder can specify if an item is to be left to one or more beneficiaries as a gift, or that an item is preferred to be bequeathed to one beneficiary who should share the monetary value with other beneficiaries. The account holder can also suggest that the beneficiaries appraise and/or sell an item privately and divide the monetary value by percentages, or that the beneficiaries share a family heirloom, for example, and rotate possession over time or delay the sale to the future. The account holder can also specify that certain beneficiaries can dispute an outcome (using the Other field which has options for dispute), bid for an item alongside the other beneficiaries, indicate that the item be sold in an estate sale or request an item be placed in storage (again using the Other field which has options to indicate estate sale or storage).

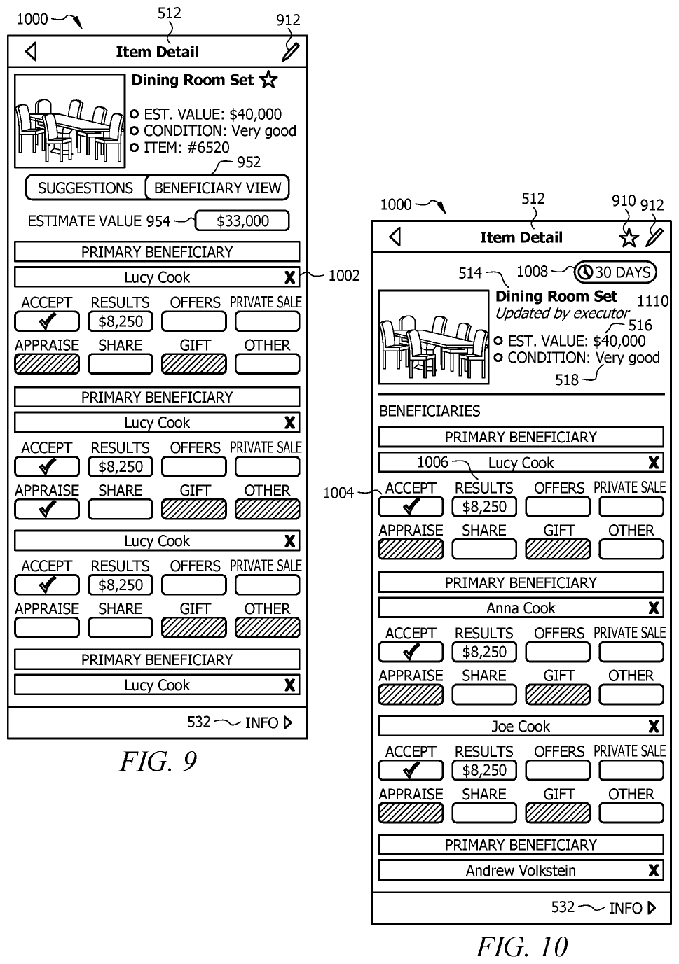

FIG. 8 shows an exemplary view of an Item Detail screen 900 including a feature 914 of a keyboard interface. As changes are made in the Item Detail screen (either Suggestion View or the Beneficiary View) with the keyboard, as to a percentage share for the beneficiaries, for example, data fields in FIG. 7-10 are refreshed with new percentage amounts automatically. The system comprises an interactive user interface that includes the “calculator tool” or function to be used by users with different permissions and abilities to determine the ultimate value and division of each item. More particularly, the primary user (account holder) can toggle back and forth between the two interfaces (Suggestions view and Beneficiary view) with the calculator tool during his or her life. The first view of this calculator tool (the suggestions view in FIG. 7) may include a primary user's digital worksheet, and the second view (“beneficiary's view” 952 in FIG. 9) illustrates how a beneficiary might interact with a hypothetical outcome or division in the future where the additional user might accept, decline, counteroffer or suggest other actions. More particularly, this central interactive user interface and toggle feature functions as a user-friendly and more complete interactive tool both for the primary user to use when making decisions on how to fairly divide personal belongings among beneficiaries.

FIG. 9 illustrates an example display of an item detail displaying the beneficiary view 952 for the account holder or primary user. As indicated above, the account holder can toggle between the suggestions view 902 shown in FIG. 7 and the beneficiary view 952 in FIG. 9. The account holder can make hypothetical entries to test how, in the future, the beneficiaries will see and may interact with the suggested division in order to confirm account holder's choice in the suggestion's view as a worksheet. The account holder utilizing the beneficiary view 952 can make multiple offers by any beneficiary, or counteroffers, decline a gift, withdraw an offer, decline the item where it was preferred to be given to a beneficiary (while sharing in the financial value of that item with others) and view how the decisions suggested might be viewed by the beneficiaries in the future. The beneficiary view 952 can function as a temporary worksheet, as all entries are automatically deleted when navigating back from the beneficiary view screen to the suggestions view 902.

In an embodiment, both the suggestions view 902 and beneficiary view 952 can function as a type of calculator, with a change made in one field automatically causing the values in other fields to be recalculated and updated accordingly. For example, in FIG. 9, a temporary estimated value may be entered at 954, such as $33,000 for a dining room set. If four beneficiaries are entered, and the amount is split evenly, and automatically entered so that each beneficiary would get $8, 250 at least in theory if all four beneficiaries accept and if there is a private buyer, or if one of the five beneficiaries has made such an offer; where they would take possession of the item but pay each of the other beneficiaries the amount accepted.

In FIG. 12, if one beneficiary (out of four beneficiaries), Andrew Volkstein, offered $24,750 for the dining room set, and the other three beneficiaries accepted the offer, the resulting dollar amounts will be calculated and each will receive $8,250 or one-third of the offered amount as a shared inheritance. Andrew could then transfer those funds to the four other beneficiaries listed, either from his own monetary inheritance or personal funds. In an embodiment, the system can also function as a point-of-sale (POS) system between beneficiaries for this purpose.

As a further example to clarify the calculator feature, if Andrew had valued the dining room set at $30,000, and if that purchase price was accepted by the other three beneficiaries, then the fields would have immediately recalculated to $10,000 each and an Item checkbox would be checked for Andrew Volstein.

In an embodiment, the executor may have access to both the so-called suggestions and the beneficiary's screen in a version of the invention where the primary user is deceased or incapacitated. More particularly, the executor may often serve as both executor and as a beneficiary.

In an embodiment, the executor(s) and primary beneficiaries may also have unique permissions to interact with the user interface of this dynamic calculator screen. For each item listed, these selected beneficiaries may have options to make bids on an item, bid on an item with proceeds to be paid to a charitable organization, decline a gift by stating that they were not interested in inheriting the item but prefer a financial bequest or assign to a different beneficiary instead, recommend the item is appraised or sold privately to increase its value to the estate, recommend the item is stored, physically share the item with other beneficiaries over time as an heirloom, suggest selling the item in an estate sale, dispute an action and pause the auction, accept a result and all within the time constraints of an auction. More particularly, additional users could communicate with an executor via push notifications or other electronic means, and any number of users may receive time sensitive alerts as to actions being taken on specific items, such as favorites flagged. Specifically, an auction with a start and end time 1008 specified by the primary user or executor(s) would take place on each item regardless if a bequeathed item was simply gifted to a beneficiary as that beneficiary might decline or prefer other action be taken on their behalf.

In an embodiment, a beneficiary, during a future auction held after the account holder's death, can make a higher offer during the time constraints of the auction. In this case, the proceeds could be immediately calculated and recalculated between other named beneficiaries as specified by the account holder in the suggestions view 902. More particularly, the amount offered must be higher than a previous offer or a private sale offer, as indicated in the settings screens by the account holder. More particularly, a beneficiary may be indicated to receive an item but decline and choose to share the financial value with others, who in turn may bid on the item, or accept the division as indicated. Alternatively, if the account holder was a supporter of a charitable organization, the list of beneficiaries may include other beneficiaries named solely to bid on an item where the proceeds are to be paid to the charitable organization.

FIG. 10 illustrates a beneficiary user interface 1000 that would be shown to a beneficiary user upon log in, after the death of the account holder. The beneficiary user interface 1000 may include a similar item detail screen to that of account holder's hypothetical beneficiary view 952. The beneficiary user interface 1000 may include item number 512, item title 514, item value 516, item condition 518, item image 526, favorite button 910, and edit button 912, for example. The beneficiary user interface 1000 may also include a list of beneficiaries 1002 and an indication of the status 1004, such as acceptance, of the offer of value 1006, such as $8,250 regarding this item. For example, if primary beneficiary Lucy Cook was the user logging in to view the beneficiary user interface 1000, she could choose to accept the offer by clicking the box at 1004. In an embodiment, the beneficiary user may also view the status of the offers from the other beneficiaries. In an embodiment, the beneficiary user may only view their own status and values and the other users are hidden. In another embodiment, only the executor can view all of the beneficiary users' statuses.

The beneficiary user interface 1000 may also include an indication of time 1008. For example, the indication of time 1008 may indicate 30 days, which refers to the auction tool explained below. In this example, with 30 days remaining on the time limitation, all other beneficiaries have accepted the offer by beneficiary Andrew Volkstein (name shown at bottom). The beneficiary user can choose other options rather than acceptance of the offer. For example, the beneficiary user may make an offer, request a private sale, request an appraisal, offer to share the item or select other (and be given further options). In some cases, some of the options are not available to a particular user and may be grayed out. These restrictions may be set by the account holder or by the executor.

The beneficiary user may have the ability to make offers, receive a gift, suggest an appraisal, decline an item, recommend storage or an estate sale, dispute an item, recommend a private sale, or share the item physically over time. The beneficiary user may also decide if he wants to bid on an item, accept or decline a gift, or in declining the gift open the item to an auction between other beneficiaries. More particularly, each beneficiary may only make entries into their own fields, and not those of the other beneficiaries.

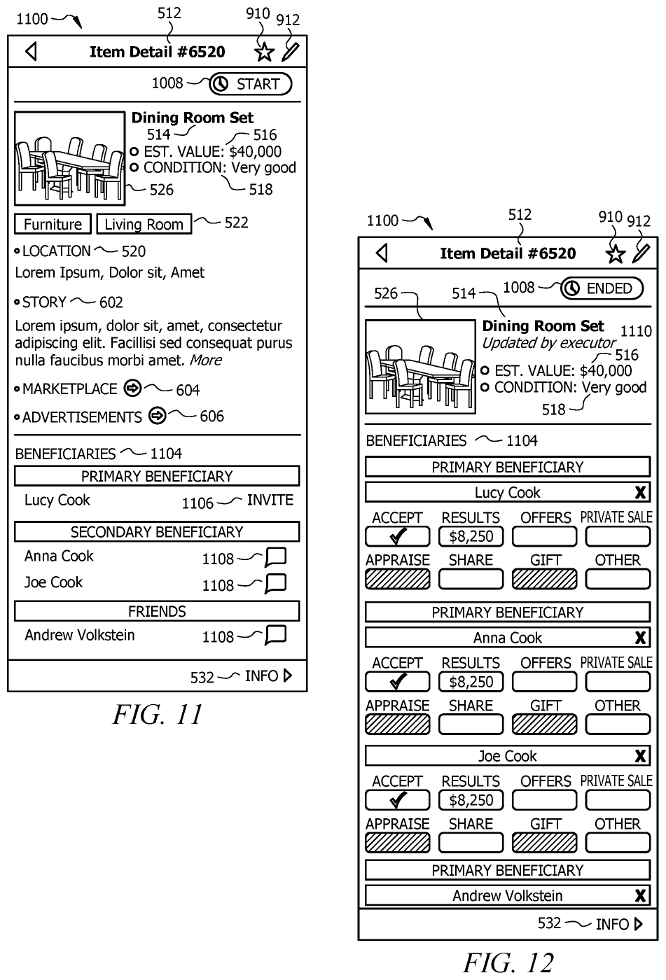

In an embodiment, the executor may create (or start) an interactive auction as shown in auction user interface 1100 of FIG. 11 using button 1008. The auction user interface 1100 may include item number 512, item title 514 (updated by the executor), item value 516, item condition 518, item location 520, item category 522, item image 526, story 602, a link to marketplace 604, and a link advertisements 606, similar to item detail user interface 600. The auction user interface 1100 may also include an indication 1110 if the details have been updated by executor. Additionally, the executor may set a time limitation, such as 30 days for the auction, which would begin once the executor presses the start button 1102. The auction user interface 1100 may also include an indication 1110 if the details have been updated by the executor. Additionally, the executor may set a time limitation, such as 30 days for the auction (which may be indicated by the account holder in settings), which would begin once the executor presses the start button 1008. The auction user interface 1100 may include a beneficiary listing 1104, which can list beneficiary users and their respective categories. For each beneficiary user, there may be an invite icon 1106 and/or a message icon 1108 (if the user has already been invited). When the executor presses the start button 1008, alerts may simultaneously be sent to each beneficiary identified in the system. An auction would end once all beneficiaries have accepted the outcome, or if the auction has timed out.

FIG. 12 shows a beneficiary user interface 1000 (similar to FIG. 10) but when the auction has ended, as indicated by time indication 1008 saying “ended” at the top of the screen. Additionally, a beneficiary may be provided a results interface that lists items associated with the beneficiary, and an indication of the status of each item, such as “gift accepted.” The results interface may also include a chat button to allow user to message the executor. The results interface may provide a summary of the auction to the beneficiaries. Additionally, a final report can be electronically sent to all beneficiaries detailing how all items are being distributed.

At the conclusion of an auction, i.e., when the time limit set for the auction has been reached, a pop-up window may be shown on the screen to inform the users. Additionally, the executor may have the ability restart the clock, or begin the auction again to allow the beneficiaries to come to a mutually beneficial agreement. In an embodiment, a transfer item feature may be provided, where one beneficiary can transfer a specific item to another beneficiary to help solve a dispute or issues of fairness between beneficiaries.

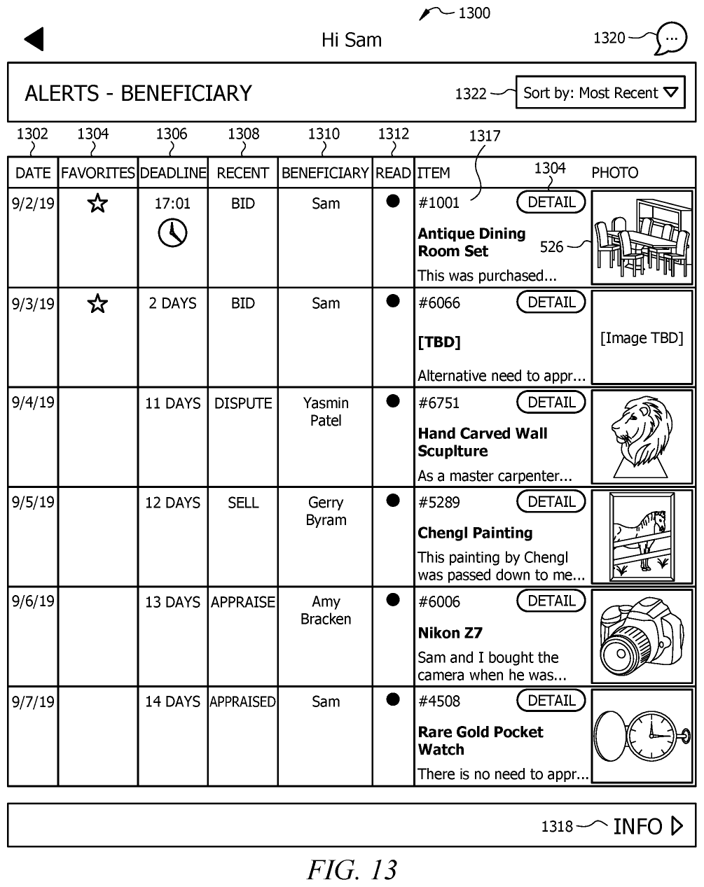

FIG. 13 illustrates a beneficiary alert interface 1300. Alerts can be sent as reminders that other beneficiary users have taken action on a “favorite” item, or that an action has been taken by another user that could influence the outcome of an item for which the current user has been named. The beneficiary alert interface 1300 may include a chart showing each item 1317 and associated properties such as date 1302, favorites 1304, deadline 1306, recent actions 1308, beneficiaries 1310, and read indication 1312. The details item 1317 may include a clickable detail button 1304 to allow access to the details of the beneficiary user interface 1000 such as shown in FIG. 10. The beneficiary alert interface 1300 may include an info button 1318 and/or a messaging button 1320. The beneficiary alert interface 1300 may be sorted and the type of sorting can be changed at icon 1322, such as to sort by most recent, by beneficiary, or by date, for example.

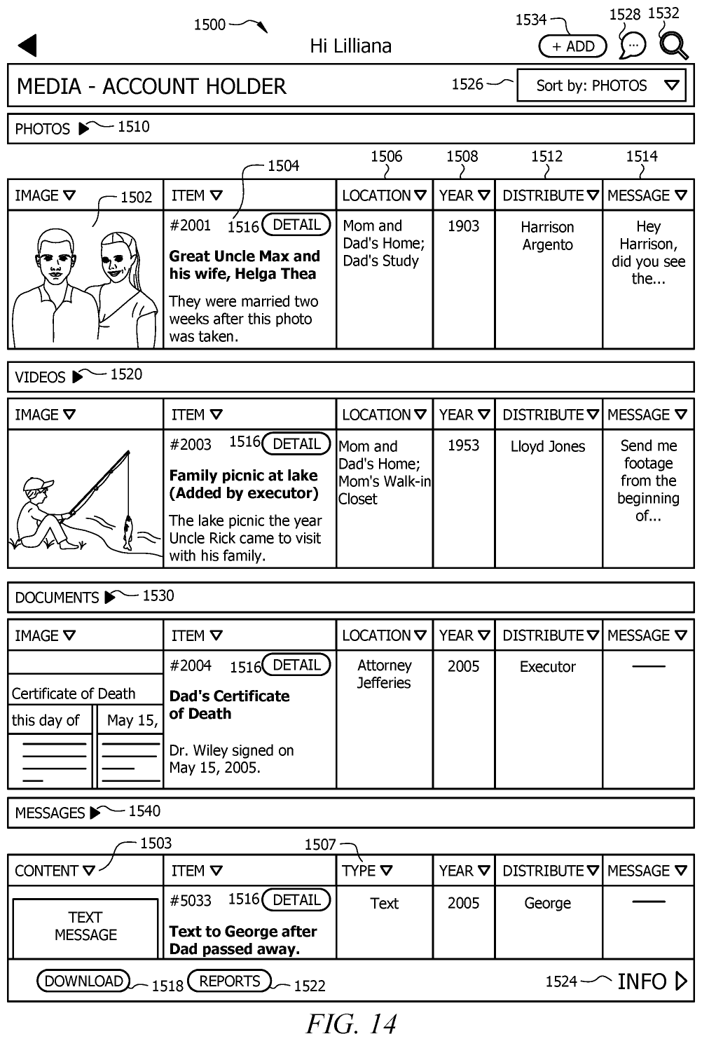

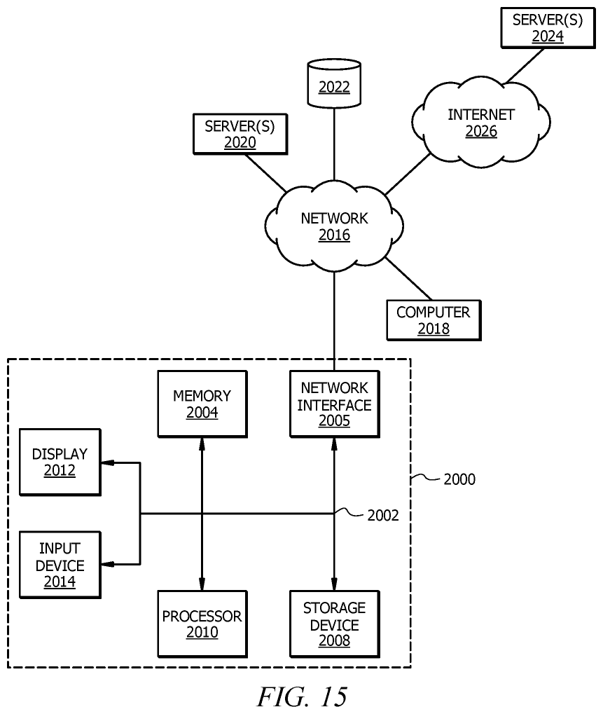

FIG. 14 illustrates a media interface 1500 owned by the account holder for display to the users. For example, photos and videos can be uploaded to the application and stored in albums as family photos and mementos. This media section may enable the storage of documents, family photos, messages, and videos for use when the account holder is alive, and for distribution after the account holder's death. Each photo or video can be assigned for the executor to distribute to one or more beneficiaries. In an embodiment, some items may be restricted, such as by designating as “private,” to limit distribution to only the users listed for that particular item per the account holder's instructions. Messages may include personal videos saying goodbye and/or personal messages as mementos to be distributed to beneficiary users.

In an embodiment, the media portion may be used to communicate mementos and/or gifts, to non-beneficiaries. Thus, the media portion may enable the executor to communicate with other people who may have been important to the account holder. Communication may be initiated by the executor or beneficiary users as specified by account holder.

The media interface 1500 may include sections for different types of media such as photos 1510, videos 1520, documents 1530, and messages 1540. Each entry may include an image 1502, an item 1504, a location 1506, a year, 1508, a person(s) to distribute to 1512, and a message 1514. With respect to the message 1540, the image 1502 may instead be content 1503, and the location 1506 may be replaced with the type of message 1507. Each item 1504 may include an item number, a description, an indication of who added the item, and a clickable detail button 1516. Additional buttons may be provided in media interface 1500, such as download button 1518, reports button 1522, and info button 1524. The media interface 1500 can be sorted and the type of sorting can be changed at icon 1526, such as to sort by photos, by distribution person, or by date. The media interface 1500 may include a messaging button 1528, search button 1532, and an add button 1534.

The system and method may further provide the users the ability to send messages to each other. For example, the executor may send a message to one or more beneficiary users to negotiate and fairly divide up the items. The system and method may include a message interface that may include, for example, a list or table showing each item and associated messages with dates, executor, title, and read indication. The message list may be sorted a variety of ways, such as by date/time, by beneficiary, or by item.

The system and method may further include a password vault interface, similar to 1500, but for storing passwords and account information, that enables the account holder to store the passwords for their various accounts, such as computing devices, emails, internet sites, social media platforms, memberships, subscriptions, banks, brokerage houses, etc. The passwords can be stored with various levels of security and available to either the executor and/or beneficiary users for access to these accounts. In addition, the executor could use the password vault to access all types of online accounts to eventually close the estate including phone, utilities, social media, memberships, financial (including cryptocurrency), real estate and digital media which might include URLS or non-fungible tokens (NFT), and/or distribute where needed as part of the catalog of personal belongings of account holder and which may be bequeathed or otherwise distributed to beneficiaries.

The system and method may further include a marketplace interface to enable the account holder to enter information regarding a vendor or collector who may be interested in purchasing a specific item. This information may be helpful to the account holder or executor to facilitate a private sale or obtain an appraisal. The marketplace interface may include contact information, a URL, an email address, a telephone number, and address, and a description. In an embodiment, vendors may be sorted by postal code and could advertise on the application to market their services to the account holder and executor.

In an embodiment, links to online legal companies with services including providing last wills and testaments, codicils, power of attorney forms and other legal documents relating to estates could be provided.

In an embodiment, an executor of an estate (which did not have the application associated with a primary user), may purchase the application separately with some differences. In this version, the executor, such as the executor, would have full access and permissions to oversee the distribution of personal belongings of the estate. Additionally, the application may apply to a general business application to manage and oversee collections or auctions where individuals are invited to bid on items belonging to a company.

In an embodiment, an estate sale manager may purchase a different version of the application, with features for an executor of an estate to communicate with the estate sale manager, and which can allow beneficiaries to make purchases of remaining items for sale at the estate sale. More particularly, the account holder may specify in settings how the proceeds are to be distributed to beneficiaries. In an embodiment, the estate sale manager may use the application to manage multiple estates over time where there is no active communication with an executor or beneficiaries of the estate.

FIG. 15 is a diagram illustrating an example computing operating environment or architecture for implementing various aspects described herein. The computer 2000 may be a desktop computer, a laptop computer, a server computer, a mobile device such as a mobile phone, tablet computer, laptop computer, desktop computer, or any other form factor of general- or special-purpose computing device containing at least one processor. The computer 2000 includes a system bus 2002, via which other components of the computer 2000 communicate with one another. In certain embodiments, there may be multiple busses or components may communicate with each other directly. Connected to the system bus 2002 is a memory 2004, a network interface (e.g., wired or wireless) 2006, a storage device (e.g., any form of computer-readable media, such as non-transitory computer readable media, and may be installed internally in the computer 2000 or externally and removably attached) 2008, a processor 2010, a display 2012, and input devices (e.g., keypad, keyboard, touch screen, touch pad, mouse, etc.) 2014. In some embodiments, a graphics card providing an input to display 2012 may not be a physically separate card, but rather may be integrated into a motherboard or processor 2010. The graphics card may have a separate graphics-processing unit (GPU), which can be used for graphics processing or for general purpose computing (GPGPU). The graphics card may contain GPU memory. In some embodiments no display is present, while in others it is integrated into the computer 2000. Like the display 2012, these peripherals may be integrated into computer 2000 or absent.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

The network interface 2006 is communicatively coupled to the system bus 2002 to enable the computer 2000 to communicate over a network such as network 2016. The network interface 2006 can be any form of network interface known in the art, such as Ethernet, ATM, fiber, Bluetooth, WiFi (i.e., the Institute of Electrical and Electronics Engineers (IEEE) 802.11 family of standards), and cellular. The network interface 2006 connects the computer 2000 to network 2016, which may also include one or more other computers, such as computer 2018, and network storage, such as cloud network storage. The network 2016 is in turn connected to public Internet 2026, which connects many networks globally. In some embodiments, the computer 2000 can itself be directly connected to the public Internet 2026.

In some embodiments, a machine learning model is provided in the context of a computer hardware and software architecture environment. In an embodiment, machine learning may include supervised learning and/or unsupervised learning. Supervised learning is defined by labeled datasets that are used to train algorithms into classifying data and/or predicting outcomes. Supervised learning may include classification algorithms and regression algorithms. Classification algorithms may include linear classifiers, support vector machines, decision trees, and random forest. Regression models include linear regression, logistic regression, and polynomial regression.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

Computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “computer-readable medium” refers to any computer program product, apparatus and/or device, such as for example magnetic discs, optical disks, memory, and Programmable Logic Devices (PLDs), used to provide machine instructions and/or data to a programmable processor, including a computer-readable medium that receives machine instructions as a computer-readable signal. The term “computer-readable signal” refers to any signal used to provide machine instructions and/or data to a programmable processor. The computer-readable medium can store such machine instructions non-transitorily, such as for example as would a non-transient solid-state memory or a magnetic hard drive or any equivalent storage medium. The computer-readable medium can alternatively or additionally store such machine instructions in a transient manner, for example as would a processor cache or other random-access memory associated with one or more physical processor cores.

Many different arrangements of the various components depicted, as well as components not shown, are possible without departing from the scope of the claims below. Embodiments have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims. Although described with reference to the embodiments illustrated in the attached drawing figures, it is noted that equivalents may be employed, and substitutions made herein without departing from the scope as recited in the claims. The subject matter of the present disclosure is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be understood by one skilled in the art and are intended to be captured within the scope of the present claims. Terms should not be interpreted as implying any particular ordering of various steps described unless the order of individual steps is explicitly described.

The features of the present invention which are believed to be novel are set forth below with particularity in the appended claims. However, modifications, variations, and changes to the exemplary embodiments of the inventive concepts described above will be apparent to those skilled in the art, and the described herein thus encompasses such modifications, variations, and changes and are not limited to the specific embodiments described herein.

What is claimed is:

1. A non-transitory computer-readable medium having encoded thereon computer-executable instructions that, when executed by a processor, perform a method for documenting and distributing items associated with a first user's estate to a plurality of beneficiaries, the method comprising:
providing a primary user interface to the first user associated with a first set of permissions, wherein the first set of permissions is unrestricted;
receiving, via the primary user interface, information associated with at least one item for storage in a database, wherein the at least one item is associated with the first user's estate, wherein the information associated with the at least one item includes data selected from the group consisting of: an item title, an item number, an item value, an item condition, an item location, a photo or video, and a story or text associated with the item;
receiving, via the primary user interface, information associated with the plurality of beneficiaries for storage in the database, wherein the information associated with the plurality of beneficiaries include data selected from the group consisting of: name, relationship, address, telephone number, email address, and an association to the at least one item;
providing a beneficiary user interface to the plurality of beneficiaries associated with a set of beneficiary permissions configurable by the first user via the primary user interface; and
wherein the primary user interface is configured to alternately display a suggestions view and a beneficiary view to the first user, wherein the suggestions view is configured to receive an input including a type of distribution for the at least one item, and the beneficiary view is configured to receive an hypothetical value for a distribution of the at least one item and dynamically display a hypothetical result in anticipation of beneficiaries' hypothetical participation in the distribution of the item according to the hypothetical value input by the first user.

2. The computer-readable medium of claim 1, wherein receiving the type of distribution comprises receiving a distribution method selected from the group consisting of: gifting the item, dividing by percentage, one beneficiary receiving the item but sharing the financial value with other beneficiaries, selling the item privately and dividing the proceeds by equal or unequal percentages, physically sharing the item over a time period, receiving a percentage of the proceeds of the profits from a private sale of the item, receiving a percentage of the proceeds of the profits from an auction with other beneficiaries, receiving a percentage of the proceeds of the profits from an estate sale, transferring an item received to another beneficiary, deferring receipt of the profits of an item deemed valuable when it is sold by another beneficiary in the future, transferring at least a percentage of the proceeds of the profits from an auction to a charitable organization.

3. The computer-readable medium of claim 1, wherein the suggestions view of the primary user interface comprises a dynamic calculator tool that automatically refreshes amounts in data fields as entries are made.

4. The computer-readable medium of claim 1, wherein the suggestions view of the primary user interface comprises a dynamic distribution worksheet displaying the hypothetical result in anticipation of acceptance, decline, and counteroffer by beneficiaries associated with the hypothetical value input by the first user.

5. The computer-readable medium of claim 1, the method further comprising:
providing a secondary user interface to an executor associated with a set of executor permissions configurable by the first user via the primary user interface;
receiving, via the secondary user interface, input from the executor to initiate an auction of a particular item;
sending auction invitations to at least one beneficiary associated with the particular item.

6. The computer-readable medium of claim 1, wherein the beneficiary view is only accessible by the beneficiaries only after the first user's demise, and being configured to receive choices therefrom to achieve a division of the item after the first user's demise.

7. The computer-readable medium of claim 1, wherein the primary user interface is configured to enable the first user to toggle between the suggestions view and beneficiary view so that both views function as a dynamic worksheet allowing the first user to modify input as needed to achieve a desired division of the at least one item among the plurality of beneficiaries.

8. The computer-readable medium of claim 1, wherein the primary user interface is configured to receive information associated with at least one primary beneficiary and information associated with at least one secondary beneficiary.

9. The computer-readable medium of claim 5, the method further comprising:
starting an auction clock for indicating the duration of the auction;
receiving at least one bid from a beneficiary for the at least one item; and
stop receiving any more bids upon expiration of the auction clock.

10. The computer-readable medium of claim 9, the method further comprising receiving an input from at least one of an executor and a beneficiary to extend the auction clock.

11. The computer-readable medium of claim 1, wherein the method is applicable to at least one scenario selected from the group consisting of: distribution of the first user's property items after the first user's demise, distribution of the first user's property items during the first user's lifetime, and distribution of a plurality of estates by an estate sale manager.

12. The computer-readable medium of claim 1, further comprising:
a communication interface configured to facilitate communication among the beneficiaries and the executor;
a media interface configured to receive media data for storage in the database, the media data being selected from the group consisting of: photographs, videos, messages, and documents; and
a password vault configured to receive and store passwords of the first user, and to enable access by a designated user after the first user's demise.

13. The computer-readable medium of claim 1, wherein the beneficiary user interface is further configured to display a results interface showing a summary of item distribution results.

14. A method for documenting and distributing items associated with a first user's estate to a plurality of beneficiaries, the method comprising:
providing a primary user interface to the first user associated with a first set of permissions, wherein the first set of permissions is unrestricted;
receiving, via the primary user interface, information associated with at least one item for storage in a database, wherein the at least one item is associated with the first user's estate, wherein the information associated with the at least one item includes data selected from the group consisting of: an item title, an item number, an item value, an item condition, an item location, a photo or video, and a story or text associated with the item;
receiving, via the primary user interface, information associated with the plurality of beneficiaries for storage in the database, wherein the information associated with the plurality of beneficiaries include data selected from the group consisting of: name, relationship, address, telephone number, email address, and an association to the at least one item;
providing a beneficiary user interface to the plurality of beneficiaries associated with a set of beneficiary permissions configurable by the first user via the primary user interface;
wherein the primary user interface is configured to displays a suggestions view and a beneficiary view to the first user, wherein the first user is able to toggle between the suggestions view and the beneficiary view, the suggestions view is configured to receive an input including a type of distribution for the at least one item, a hypothetical value for the at least one item, and a dynamic calculator and worksheet to enable the first user to view a dynamically calculated hypothetical result in anticipation of beneficiaries' hypothetical participation of accepting, declining, and making a counteroffer associated with the hypothetical value input by the first user in the distribution of the item; and
wherein the primary user interface is configured to enable the first user to toggle between the suggestions view and beneficiary view so that both views function as a dynamic worksheet allowing the first user to modify input as needed to achieve a desired division of the item among the plurality of beneficiaries.

15. The method of claim 14, wherein receiving the type of distribution comprises receiving a distribution method selected from the group consisting of: gifting the item, dividing by percentage, one beneficiary receiving the item but sharing the financial value with other beneficiaries, selling the item privately and dividing the proceeds by equal or unequal percentages, physically sharing the item over a time period, receiving a percentage of the proceeds of the profits from a private sale of the item, receiving a percentage of the proceeds of the profits from an auction with other beneficiaries, receiving a percentage of the proceeds of the profits from an estate sale, transferring an item received to another beneficiary, deferring receipt of the profits of an item deemed valuable when it is sold by another beneficiary in the future, and transferring a percentage of the proceeds of the profits from an auction to a charitable organization.

16. The method of claim 14, the method further comprising:
providing a secondary user interface to an executor associated with a set of executor permissions configurable by the first user via the primary user interface;
receiving, via the secondary user interface, input from the executor to initiate an auction of at least one particular item;
starting an auction clock for indicating the duration of the auction;
sending auction invitations to at least one beneficiary associated with the at least one particular item;
receiving at least one bid from a beneficiary for the at least one item;
stop receiving any more bids upon expiration of the auction clock; and
restarting the auction clock.

17. The method of claim 14, wherein the method is applicable to at least one scenario selected from the group consisting of: distribution of the first user's property items after the first user's demise, distribution of the first user's property items during the first user's lifetime, and distribution of a plurality of estates by an estate sale manager.

18. The method of claim 14, wherein the beneficiary user interface is further configured to display a result interface showing a summary of item distribution results.

19. The method of claim 14, further comprising:
a communication interface configured to facilitate communication among the executor and beneficiaries;
a media interface configured to receive media data for storage in the database, the media data being selected from the group consisting of: photographs, videos, messages, and documents; and
a password vault configured to receive and store passwords of the first user, and to enable access by a designated user after the first user's demise.

20. A system for documenting and distributing items associated with a first user's estate to a plurality of beneficiaries, the system comprising:
a processor;
a database; and
at least one non-transitory memory storing computer executable instructions configured to perform a method comprising the steps of:
providing a primary user interface to the first user associated with a first set of permissions, wherein the first set of permissions is unrestricted;
receiving, via the primary user interface, information associated with at least one item for storage in a database, wherein the at least one item is associated with the first user's estate, wherein the information associated with the at least one item includes data selected from the group consisting of: an item title, an item number, an item value, an item condition, an item location, a photo or video, and a story or text associated with the item;
receiving, via the primary user interface, information associated with the plurality of beneficiaries for storage in the database, wherein the information associated with the plurality of beneficiaries include data selected from the group consisting of: name, relationship, address, telephone number, email address, and an association to the at least one item;
providing a beneficiary user interface to the plurality of beneficiaries associated with a set of beneficiary permissions configurable by the first user via the primary user interface;
wherein the primary user interface is configured to alternately display a suggestions view and a beneficiary view to the first user, wherein the first user is able to toggle between the suggestions view and the beneficiary view, the suggestions view is configured to receive an input including a type of distribution for the at least one item, a hypothetical value for the at least one item, and a dynamic calculator and worksheet to enable the first user to view a dynamically calculated hypothetical result in anticipation of beneficiaries' hypothetical participation of accepting, declining, and making a counteroffer associated with the hypothetical value input by the first user in the distribution of the item; and
wherein the primary user interface is configured to enable the first user to toggle between the suggestions view and beneficiary view so that both views function as a dynamic worksheet allowing the first user to modify input as needed to achieve a desired division of the item among the plurality of beneficiaries.
